(19) United States
(12) Patent Application Publication
(10) Pub. No.: US 2013/0027433 A1
(43) Pub. Date: Jan. 31, 2013

(54) USER INTERFACE AND METHOD FOR MANAGING A USER INTERFACE STATE BETWEEN A LOCKED STATE AND AN UNLOCKED STATE

(71) Applicant: Anthony D. Hand, San Jose, CA (US)

(72) Inventor: Anthony D. Hand, San Jose, CA (US)

(73) Assignee: MOTOROLA MOBILITY, INC., Libertyville, IL (US)

(21) Appl. No.: 13/208,682

(22) Filed: Aug. 12, 2011

Related U.S. Application Data
(60) Provisional application No. 61/513,017, filed on Jul. 29, 2011.

(51) Int. Cl. G09G 5/00

(52) U.S. Cl. 345/650

(57) ABSTRACT

A user interface for an electronic device and method for managing a state between a locked state and an unlocked state of a user interface having a touch sensitive display are provided. The user interface has a controller including a state change module for switching the state of the user interface between the locked state and the unlocked state, when the state change module detects each of at least one display element in a respective unlock position, wherein the respective unlock position includes a placement within a respective predetermined area and a rotational direction in a respective predetermined orientation. In at least some instances, while in a locked state, a display element in a lock position can be transitioned to an unlock position and a display element in an unlock position can be transitioned to a lock position.

### FIELD OF THE DISCLOSURE

The present disclosure relates generally to managing a user interface state between a locked state and an unlocked state and, more particularly, to the movement of a display element between an area of display surface corresponding to a lock position and an area of the display surface corresponding to an unlock position, where the respective unlock position can include placement within a predetermined area and a rotational direction having a predetermined orientation, and where display elements can be moved from a lock position to an unlock position, as well as an unlock position to a lock position.

### BACKGROUND

The use of touch sensitive interfaces, including those incorporated as part of a touch sensitive display have gained in popularity for their ease of use associated with a more intuitive interaction in accessing and controlling the functionality of an electronic device including interacting with displayed elements and/or information. Furthermore, touch sensitive displays have greatly expanded the types of user interactions which can be regarded as a valid form of input. Many interfaces have made use of these expanded opportunities to extend the types of interactions that can be defined for interacting with the device and more particularly the various applications running on the device. These interactions have been expanded to include what has sometimes been referred to as gestures. In some cases, a gesture can be as concise as a brush across the touch sensitive surface. In other instances, a gesture can trace complicated patterns and include multiple points of interaction with the surface. In at least some instances, the location at which the gesture begins can be used to select a particular one of the elements being displayed with which the user wishes to interact, and the subsequent traced movement along the surface of the display defines the nature of the interaction with the displayed element selected by the user. Still further, many interfaces have been designed to allow corresponding functionality to be performed in simple and succinct ways with a trend toward involving a minimal number of steps and/or interactions which, in essence, involves a streamlining of the interactions necessary for producing a desired effect.

Correspondingly, by increasing the types of interactions that will be viewed as a valid form of input and minimizing the number of steps to produce and/or trigger a corresponding function, there is an increased chance that an unintended interaction will coincide with an interaction from the expanded list of permissible types of gestures or interactions with the possibility that it will trigger an unintended consequence. In essence, any stray movement of a body part of the user relative to the touch sensitive surface of the display has the potential to select an item being displayed with which the user can interact, and correspondingly the nature of the movement has the potential that it will be recognized as a gesture associated with a valid function that will be acted upon, and/or may trigger an action relative to the selected item. In some cases, the stray movement which is not intended to be a purposeful interaction may be repeated in a regular fashion, which can compound or magnify the resulting interaction. For example, a user's hip or leg might brush against the display surface of the device with each step as a user walks while carrying the device. Correspondingly, each stray movement, or the repeated movements when considered together, has the potential to be treated as a valid interaction despite its unintended origins.

As such, with expanded types of interactions and a set of streamlined interactions for producing an effect, it has become increasingly likely that a user can unknowingly activate functionality on the device, such as initiate a telephone call or manipulate a stored element, such as a file, including accidentally moving, copying or erasing the same through a stray interaction. In response to this, user interface developers have implemented lock screens, which temporarily disable at least a portion of the user interface, and generally require an unlock interaction before other types of interactions will be recognized. In some cases, the lock screen will be engaged after a fixed period of inactivity during which the user has not interacted with the device. In other instances, a lock screen state can be purposely initiated by the user.

However for the same reasons that users desire more streamlined user interactions for producing desired and intended functionality, any interaction associated with the unlocking of a locked user interface should similarly avoid being overly burdensome or complex, in order to avoid the user finding the use of the feature frustrating, and correspondingly disabling the feature. Hence the challenge is to develop and provide a straight forward and intuitive interaction for unlocking a locked device which is not overly burdensome, but which also can not readily be accidently initiated.

Correspondingly, the present inventors have recognized that it would be beneficial to develop an apparatus and/or approach for transitioning between a user interface locked state and a user interface unlocked state, which is intuitive and not unduly burdensome to the user, while simultaneously reducing the risk that a stray or unintended interaction could accidently transition the device to an unlocked state without the transition to the unlocked state being the express intent of the user of the device.

### SUMMARY

The present disclosure provides among other features a user interface for an electronic device or other machine. The user interface has a touch sensitive display having a display surface, the touch sensitive display being adapted for presenting to a user at a respective position having a respective orientation at least one display element along the display surface. The touch sensitive display is further adapted for receiving from the user, a user interaction with the touch sensitive display at a location along the display surface. The user interface further includes a controller. The controller includes a user interface state module having an unlocked state and a locked state adapted for selectively enabling and disabling at least a portion of the user interface, wherein the portion of the user interface responds to a predetermined type of user interaction when in the unlocked state and does not respond to the predetermined type of user interaction when in the locked state. The controller further includes a state change module adapted for switching the state of the user interface state module between the locked state and the unlocked state. The state change module switches the state of the user interface module from the locked state to the unlocked state when the state change module detects each of the at least one display element is in a respective unlock position for the corresponding one of the at least one display element. The state change module includes an area detector and an orientation detector, wherein the respective unlock position for the corresponding one of the at least one display element includes a placement within a respective predetermined area and a rotational direction in a respective predetermined orientation. When the state change module switches the state of the user interface state module to a locked state, the state change module is adapted to respectively reposition at least one display element to a respective lock position including an area of the display surface other than within the respective predetermined area of the respective unlock position and to an orientation other than the respective predetermined orientation of the respective unlock position.

In at least one embodiment, the controller further includes a lock state interface module, where the lock state interface module is adapted to detect a received user interaction including the selection by the user of one of the at least one display element, and is further adapted to detect a further received user interaction including a postselection gesture, which moves the display element from a preselection position to a postgesture position having at least one of a placement within a new area and a new orientation.

In at least a further embodiment, the at least one of placement within a new area and a new orientation by the post selection gesture includes movement of the selected one of the at least one display element from the respective lock position to the respective unlock position, and movement of the selected one of the at least one display element from the respective unlock position to the respective lock position.

The present disclosure further provides among other features a user interface for an electronic device. The user interface has a touch sensitive display having a display surface, where the touch sensitive display is adapted for presenting to a user at a respective position a plurality of display elements along the display surface. The touch sensitive display is further adapted for receiving from the user a user interaction with the touch sensitive display at a location along the display surface. The user interface further includes a controller. The controller includes a user interface state module, which has an unlocked state and a locked state adapted for selectively enabling and disabling at least a portion of the user interface, wherein the portion of the user interface responds to a predetermined type of user interaction when in the unlocked state and does not respond to the predetermined type of user interaction when in the locked state. The controller further includes a state change module adapted for switching the state of the user interface state module between the locked state and the unlocked state. The state change module switches the state of the user interface module from the locked state to the unlocked state when the state change module detects each of the plurality of display elements in respective unlock positions for each of the corresponding display elements. The state change module includes a position detector wherein the respective unlock position for a corresponding one of the plurality of display elements includes placement within a respective predetermined position, where when the state change module switches the state of the user interface state module to a locked state, the state change module is adapted to respectively reposition at least one of the plurality of display elements to a position of the display surface other than within the respective unlock position. The controller still further includes a lock state interface module, said lock state interface module being adapted to detect a received user interaction including the selection by the user of one of the plurality of display elements, and being further adapted to detect a further received user interaction including a postselection gesture, which moves the selected one of the plurality of display elements from a preselection position to a postgesture position having a placement within a new position. In addition to being adapted to move the selected one of the plurality of display elements from the respective lock position to the respective unlock position, the lock state interface module is also adapted to move a selected one of the plurality of display elements from the respective unlock position to the respective lock position.

In at least one embodiment, when the state change module switches the state of the user interface state module to a locked state, the state change module is adapted to initially establish a position of all but one of the plurality of display elements within the respective predetermined unlock position.

The present disclosure still further provides a method for managing a state of a user interface between a locked state and an unlocked state. The method includes switching a state of the user interface from the unlocked state to the locked state. The user is then presented at least one display element via a display surface of a touch sensitive display. Each of the at least one display element is presented at a respective position having a respective orientation. When the state of the user interface is switched from the unlocked state to the locked state, the at least one display element is positioned in an area of the display surface other than a predetermined area of a respective unlock position and having a rotation other than a predetermined orientation of the respective unlock position. A repositioning of the at least one display element is then detected. The state of the user interface is then switched from the locked state to the unlocked state, when each of the at least one display element is detected in the respective unlock position of the corresponding at least one display element.

These and other objects, features, and advantages of this disclosure are evident from the following description of one or more preferred embodiments of this invention, with reference to the accompanying drawings.

### BRIEF DESCRIPTION OF THE DRAWING

FIG. 1 is a plan view of an exemplary electronic device incorporating a touch sensitive interface, such as a touch sensitive display, for receiving a user interaction relative to one or more interactive elements;

FIG. 2 is a plan view of a pointer device engaging a touch sensitive surface and tracing a potential exemplary single pointer pattern movement that might be effective as a gesture;

FIG. 3 is a block diagram of a user interface incorporated as part of an electronic device;

FIG. 4 is a plan view of a sequence of a display element at different points in time as the display element is selected and repositioned as part of a detected postselection portion of a gesture;

FIG. 5 is a further plan view of a sequence of a display element at different points in time traveling along a path relative to an unlock position and a pair of avoid areas;

FIG. 6 is a further plan view of a touch sensitive display illustrating a pair of exemplary gestures for relocating and reorienting a display element;

FIG. 7 is a plan view of an exemplary gesture for reorienting a display element;

FIG. 8 is a plan view of a further exemplary gesture for reorienting a display element;

FIG. 9 is a plan view of an asymmetric display element in the form of a puzzle piece illustrating an exemplary gesture and a corresponding repositioning of the display element including placement in a new area having a new orientation;

FIG. 10 is a further block diagram of a user interface incorporated as part of an electronic device;

FIG. 11 is a plan view of a plurality of display elements each having a respective unlock position illustrating the possibility of repositioning of corresponding display elements from a lock position to an unlock position, and from an unlock position to a lock position; and

FIG. 12 is a flow diagram of a method for managing a state of a user interface between a locked state and an unlocked state.

### DETAILED DESCRIPTION

While the present disclosure is susceptible of embodiments in various forms, there is shown in the drawings and will hereinafter be described presently preferred embodiments with the understanding that the present disclosure is to be considered an exemplification of the invention and is not intended to limit the invention to the specific embodiments illustrated. Furthermore, while the various figures are intended to illustrate the various aspects of the present invention, in doing so, the elements are not necessarily intended to be drawn to scale. In other words, the size, shape and dimensions of some layers, features, components and/or regions for purposes of clarity or for purposes of better describing or illustrating the concepts intended to be conveyed may be exaggerated and/or emphasized relative to other illustrated elements.

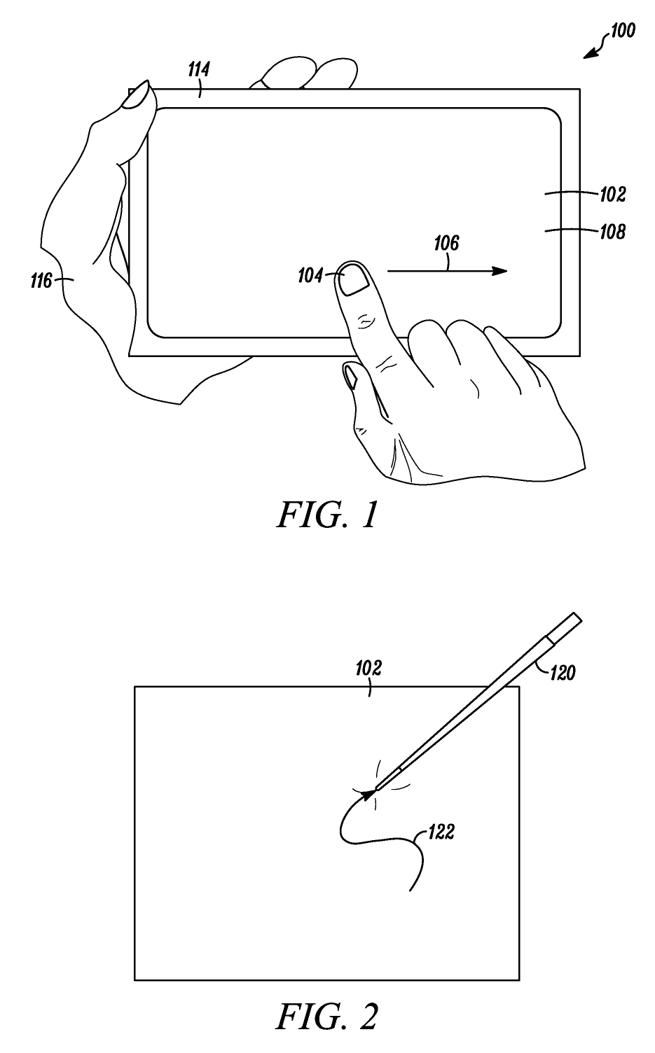

FIG. 1 illustrates a plan view of an exemplary electronic device 100 incorporating a touch sensitive interface 102. In the particular embodiment illustrated, the touch sensitive interface 102 is incorporated as part of a touch sensitive display 108, where a surface coincides with and extends to include a display, which provides information visually to the user. The surface is adapted to receive an input from a pointer, such as a user's finger 104 or other appendage, or a stylus (not shown), where the nature of the interaction of the pointer with the sensor surface defines a pattern of interaction and any related gesture 106 or movement. For example, the pattern of interaction may include touching or contacting a point on the touch sensitive interface with the pointer, or navigation or other movement of the pointer along or across the touch sensitive interface while contacting the interface or being within a predefined proximity of the interface, among other interactions between the pointer and the touch sensitive interface. The electronic device could be one of many different types of electronic devices including wireless communication devices, such as radio frequency (i.e., cellular) telephones, media (i.e., music, video) players, personal digital assistants, portable video gaming devices, cameras, and/or remote controls. The electronic device may also be a user input subassembly of some other equipment, like an appliance or other machine.

The touch sensitive user interface 102 often includes a touch sensitive array, which has position sensors that are adapted for detecting a position and/or proximity of a corresponding pointer device relative to the touch sensitive user interface 102. Many existing forms of touch sensitive arrays include arrays which are resistive or capacitive in nature. Still further, the touch sensitive array can even employ a force sensing element array for detecting an amount of force being applied at the selected location. In this way, a force threshold determination can be taken into account in determining an intended interaction including the selection of an interactive element, such as a display element, or the making of a gesture. However, the use of other forms of touch sensitive arrays are possible without departing from the teachings of the present disclosure.

While the pointer device can include a user's finger 104, a stylus, or any other suitable often times generally elongated element for identifying a particular area associated with the touch sensitive array, in some instances, the determination of an appropriate pointer may be affected by the particular technology used for the touch sensitive array, where in some instances a particular type of pointer may work better in conjunction with a particular type of array. In FIG. 1, the device 100 is illustrated as being held by a hand 116 on at least one of the (i.e. the left) sides 114 with the other hand, and more particularly a finger 104 of the other hand, being used to interact with the surface of the display of the touch sensitive user interface. Through the use of a finger 104 or a stylus, a user can produce a gesture 106 that can be detected by the device 100 through an interaction with the touch sensitive interface 102.

FIG. 2 illustrates an example of a pointer device 120 engaging a touch sensitive surface 102 and tracing a potential exemplary single pointer pattern movement 122 that might be effective as a gesture for adjusting the performance of an active controllable interface function. While generally a pointer is used to interact with the touch sensitive user interface, in reality the proximity of any item relative to the touch sensitive surface can sometime be detectable as an interaction, whether intended or not. For example, if the device is brought within proximity of a user's face, in instances where the device supports telephone calls, the user's cheek brushing up against the device has the potential of being detected as a user interaction. As such, devices have used lock screens to help reduce the circumstances in which anticipated or unanticipated unintended interactions are erroneously detected as a device input. However, because a user needs to be able to navigate away from the locked state in order to interact with the device, but at the same time you do not want the device to be accidently unlocked by the same unintended interactions that the lock screen was intended to filter, the lock screen and the particular action on the part of the user necessary for unlocking the device, become a balance between effectively filtering unintended interactions, and not requiring an overly complex interaction for enabling the user to transition the device back to an unlocked state.

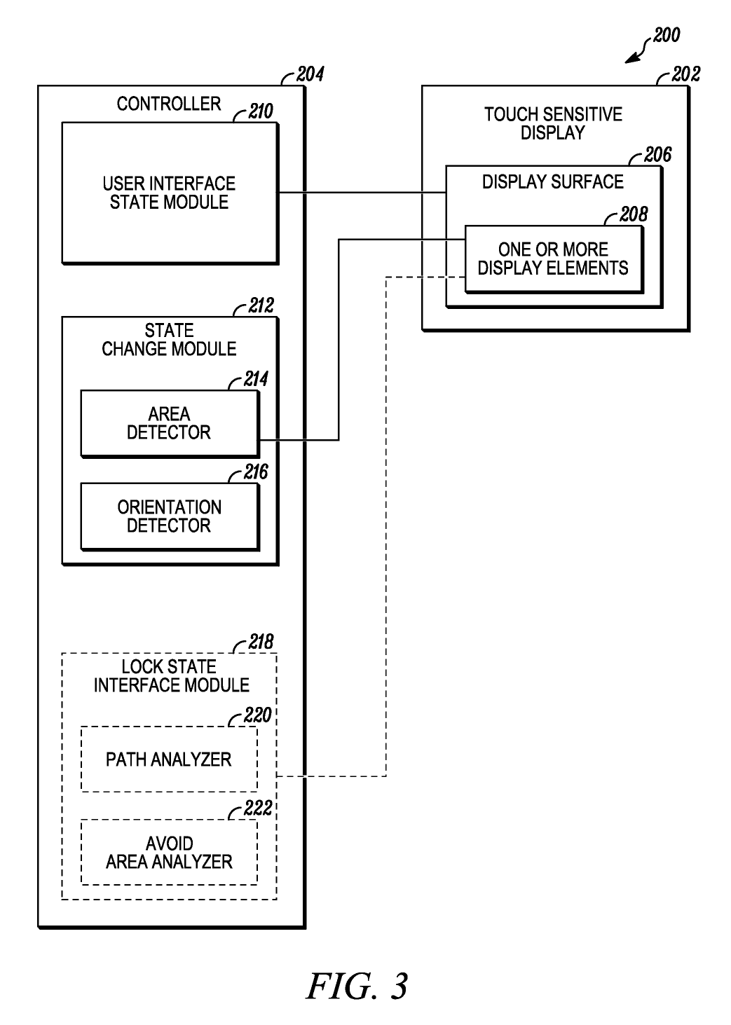

FIG. 3 illustrates a block diagram 200 of a user interface incorporated as part of an electronic device. The user interface includes a touch sensitive display 202 and a controller 204. The touch sensitive interface 202 includes a display surface 206 including one or more display elements 208 for presentation to the user via the display surface with which the user can interact. The display surface 206 of the touch sensitive display is adapted for receiving a gesture or pattern of interaction from a user either directly, for example 106 in FIG. 1, or indirectly via a pointing device, for example 122 in FIG. 2. The detected gesture or pattern of interaction can then be interpreted in order to discern a desired action on the part of the user.

However as noted previously not all interactions detected via the touch sensitive display may be the result of a desired action on the part of the user. In some instances an unintended interaction with the device may be made and detected proximate the touch sensitive surface of the device. As such, in some circumstances, it may be desirable to have the touch sensitive surface be in a locked state, which limits the nature and type of interactions that will be detected as a valid user input. Generally, while in a locked state the user interface will be focused on those particular actions which are intended on contributing to the transition of the user interface back to an unlocked state. The state of the user interface between a locked state and an unlocked state is managed by the controller 204. In support of this function, the controller 204 includes a user interface state module 210, which selectively enables and disables at least a portion of the user interface, including the types of interactions to which the interface will respond.

The controller further includes a state change module 212, which is adapted for switching the state of the user interface, which is managed by the user interface state module 210, between a locked state and an unlocked state. The state change module switches the state of the user interface module from the locked state to the unlocked state when the state change module detects that each of the at least one display element is in its respective unlock position, which generally includes placement within a respective predetermined area. In order to determine when the display elements are each in their respective predetermined areas of their unlock positions, the state change module includes an area detector 214. In addition to being within a respective predetermined area, in at least some instances a respective unlock position will additionally have a respective predetermined orientation. In order to determine when the display elements are each in their respective predetermined orientations of their unlock positions, the state change module further includes an orientation detector 216.

The controller 204 can in some instances still further include a lock state interface module 218 which manages the functioning of at least a portion of the device while the user interface is in a locked state. As part of that management, the lock state interface module 218 may monitor interactions with the touch sensitive surface of the display, and detect interactions with elements being displayed during the locked state of the user interface state module 210. The lock state interface module 218 further manages the elements 208 being displayed including their subsequent selection and movement including those intentionally or unintentionally prompted by the user, while the device is in a locked state.

When in a locked state, the user interface presents to the user at least one display element having a current respective position and a current respective orientation. In at least some instances, the act of unlocking may require a selection of a display element, and corresponding movement of the display element from a lock position to an unlock position. In these instances, in order to interact with the display element, the user needs to initiate a selection of the display element. Generally, the lock state interface module 218 will detect a user gesture including an attempted selection of a display element proximate the beginning point of a detected gesture, and a subsequent path that is traced by the pointer device until the tip of the pointer device is disengaged from its position proximate the surface 206 of the display. The subsequent path is sometimes referred to as a postselection portion of a gesture, and will sometimes define an action that can be used to affect the current position of the particular display element, if any, that has been selected. For example in some instances, the postselection portion of the gesture can define a displacement and corresponding path of the selected display element, where an updated position of the display element will generally correspond to the end point of the postselection portion of the gesture.

While a user can visually detect a display element's current position, unintended interactions are generally blind. Correspondingly, an unintended interaction will only select a particular display element in instances where the unintended interaction coincides with the current location of the display element, when the unintended interaction with the display surface is first detected. Furthermore, because the display element has an orientation, the orientation can be used to further define an unlock position. In such an instance, it is not sufficient to move the display element to the particular location corresponding to the unlock position, but when at the unlock position, the display element needs to have the correct orientation. Adjusting an orientation can involve one or more of several possible interactions with the display element, and in at least some instances can be a function of the particular path during the postselection portion of the gesture that is detected. In the same or other instance, an adjustment to orientation can be affected through a subsequent interaction with a display element. By layering the further feature of an orientation in addition to the feature of a particular location, in order for an unlock condition to be detected a second match with regards to orientation needs to be present at the same time a first match with regards to location occurs. The likelihood that both matches occur unintentionally at the same time is far less than the likelihood of an unintentional match occurring that relies exclusively on location.

Still further, an analysis of the path defined by the postselection portion of the gesture can be used to detect an unintentional interaction, where in these instances the particular area through which the display element is said to travel can include areas, which are to be avoided. As noted previously, because unintentional interactions are generally blind, they generally cannot purposely avoid a particular area. At least not in the same manner in which a person that is consciously controlling the movement of a display element can detect and avoid a particular area. As such in some instance, the lock state interface module 218 can include a path analyzer 220, which can include an avoid area analyzer 222.

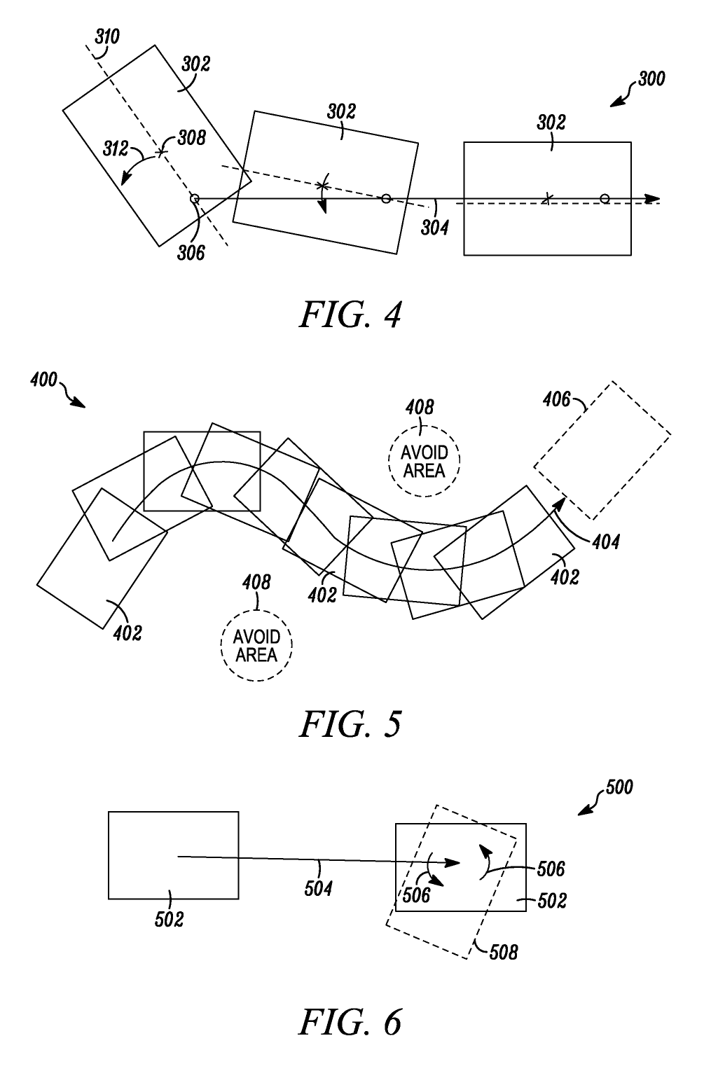

As part of managing the movement of a display element when the user interface is in a locked state, the position and orientation of a display element can be managed by one or more gestures detected proximate the surface of the touch sensitive display. In some cases, a single gesture can affect both the position and orientation of the display element. In other instances, a particular gesture will affect position, and another separate gesture will affect orientation. FIG. 4 illustrates a plan view 300 of a sequence of a display element 302 at different points in time as the display element is selected and repositioned as part of a detected postselection portion of a gesture 304. At the far left of the sequence a rectangular display element 302 is shown. A circle 306 at one end of the display element 302 represents a point on the display element that is designated, when the gesture selecting the display element is initiated. In the example illustrated, the circle 306 is the point via which the display element 302 is pulled as part of the movement of the display element as it attempts to follow the path traced by the postselection portion of the gesture 304.

An “X” represents a virtual center of mass 308 of the display element, and a dashed line 310 extends between the center of mass 308 and the point at which the display element 302 is selected. As the display element 302 is pulled along the path corresponding to the postselection portion of the gesture, the display element can be designed to naturally rotate 310 with the center of mass of the display element rotating so as to tend to follow the traced path. In this way, a single gesture can be used to affect a change of location as well as a change of orientation, where it is equally important where the gesture ends as well as the direction of movement proximate the end of the gesture 304. Both would need to combine to result in a match with an unlock position that includes both a predetermined location and a predetermined orientation.

FIG. 6 illustrates a further plan view 400 of a sequence of a display element 402 at different points in time traveling along a path 404 relative to an unlock position 406 and a pair of avoid areas 408. As the display element travels along the traced path 404, the orientation of the display element rotates so as to follow the direction of the path. In this way, the orientation can be adjusted so that as the display element approaches to possibly eventually coincide with the identified unlock position 406, that the display element 402 is oriented so as to similarly match both a location and an orientation. As illustrated, if the display element continues on its current path, the display element is in line to match both a position and an orientation as illustrated by the outline corresponding to the unlock position 406. The illustrated path 404 similarly highlights how a pair of areas can be avoided, which can be used to force more than a random blind approach that has an end point that coincides with the location of the unlock position.

In at least some instances, an avoid area 408 can be used to restrict the types of valid paths that can be used to transition the display element 402 from its original lock position to an unlock position 406. For example, in some instances if the display element intersects with an avoid area 408 the user interface might interrupt the gesture currently transitioning the display element 402 to a new location, and in some instances may return the display element 402 to its preselection position. While, intuitively, the same transition needs to occur to effect an unlocking of the user interface, by requiring that the manner in which the transition takes place results in a display element having a particular location and orientation (as well as possibly needing to avoid certain paths), the number of potentially unintentional interactions that will produce a result that unlocks the device is minimized without significantly increasing the burden on the user from a conceptual and implementation viewpoint when the necessary goal to unlock the device is being purposely pursued.

In at least some instances, when the device transitions from an unlocked state to a locked state, the position of the at least one display element is randomly repositioned away from the unlock position, such that it deviates from the expected unlock position a random amount in a random direction having a rotation that differs a random amount from the orientation of the unlock position. In such an instance, the particular motion that will produce a display element being properly situated in the unlock position may be different each time. However it is not necessary for the required position, orientation and path for unlocking the device be different every time. In other words, the same or similar lock and unlock positions could be used which does not change without departing from the beneficial teachings of the present application. Furthermore, the particular lock position and unlock position including the respective locations and orientations (and avoid areas, if any) could in some instances be defined by the user.

While FIGS. 4 and 5 illustrate how path direction of the postselection portion of a gesture could be used to manage at the same time a change in both location and orientation, it is possible that multiple sequential gestures could be used to transition a display element from a lock position to an unlock position. Furthermore some of the gestures may primarily result in a change in location, while other gestures may primarily result in a change in orientation. FIG. 6 illustrates a plan view 500 of a touch sensitive display illustrating a pair of exemplary sequential gestures for both relocating and reorienting a display element 502. In the illustrated embodiment, a first gesture 504 relocates the display element 502 from a start location to a location that is proximate the location of the unlock position 508. A second gesture 506 is then used to rotate the display element 502 so as to have an orientation that coincides with the orientation of the unlock position 508. In some instances a multiple point gesture can be used to produce a rotation in the display element 502. In other instances a single point gesture can be used.

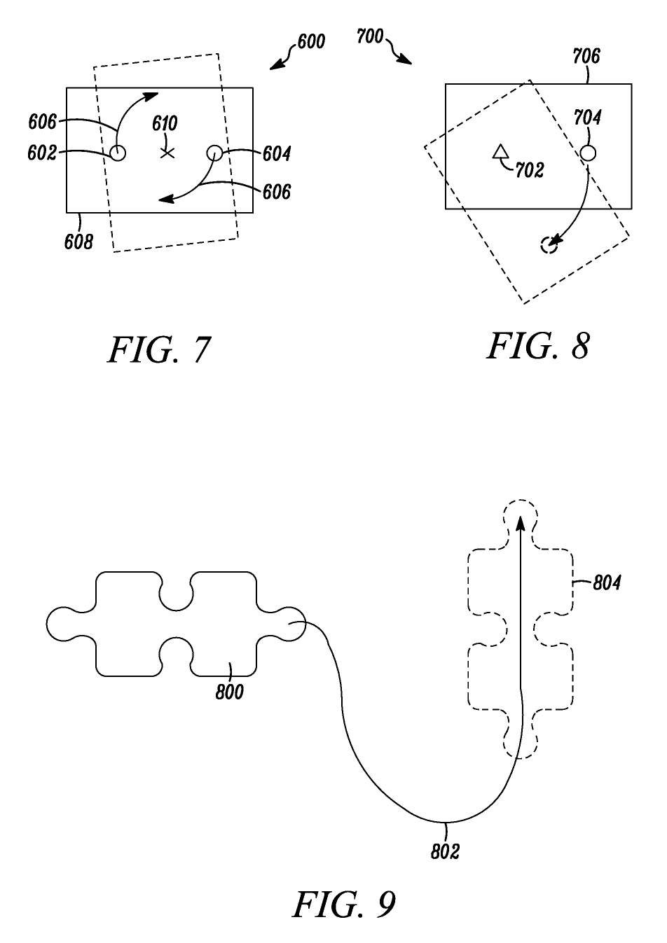

FIG. 7 illustrate a first example 600 of a multiple point 602 and 604 gesture 606 for reorienting a display element 608. Such a gesture would allow a rotational movement to be defined where each of the points on the display element that are selected are allowed to rotate in a pattern proximately reflecting the rotational nature of the gesture. In some instances a point 610 of rotation could be determined, where the particular point determined might be a point midway between the two selected points 602 and 604. In other instances, such as a second example 700 illustrated in FIG. 8, one of the two selected points might serve as a pivot 702, and the corresponding movement relative to a second selected point 704 could define the direction and the amount of rotation of the display element 706. It is further possible that other types of gestures which generally define a rotational type of movement could alternatively be used including single point gestures. For example an unselected pivot point could be determined for the display element selected which is proximate the center point, such as a center of mass as illustrated in FIG. 4, of the display element. The selected point could then be moved in an approximate rotational direction about the pivot point, which is determined from the size and shape of the selected display element.

While for simplicity sake, display elements in FIGS. 3-8 have been generally shown to be rectangles, one skilled in the art will readily appreciate that display elements having any size or shape could be used including display elements shaped like a puzzle piece 800, as shown in FIG. 9. Furthermore, the appropriate unlock position for the puzzle piece can be determined by its relationship to other puzzle pieces, where in at least some instances a picture that extends across the puzzle pieces as well as the shape of the surrounding pieces will help to define the proper position of each piece, relative to one another. In at least some instances, an initial default state of the lock screen includes a majority of the pieces already in their correct position, which results in one or a couple of pieces that are out of place (i.e. not in their respective unlock position). A larger number being out of place as part of an initial starting condition of a locked state would generally make the task of unlocking the phone more about finishing a puzzle and less about changing the state of the user interface. In instances where only a few pieces are initially out of place, an out of place piece can generally be readily matched to its proper location. Even still, the piece can still be both laterally as well as rotationally displaced. As such, where the path of a postselection gesture could be used to change orientation, a single gesture including selection and subsequent postselection movement can be used to simultaneously change a piece's location and its rotation in order to properly position a display element in its unlock position.

In FIG. 9, a path 802 is illustrated which can result in the piece being properly positioned including location and orientation in order that the piece is placed in its respective unlock position 804. Alternatively if the piece were to approach from another direction, the piece might not be properly oriented and the user interface would generally remain in a locked state until a further gesture was detected which resulted in the proper rotation of the piece 800. This in turn significantly reduces the chances of an inadvertent unlocking of the device, as it requires more than just a repositioning of the display element. At least one advantage of the display element being shaped as a puzzle piece or another asymmetric shape, as opposed to a rectangle, is that the shape of the display element can provide a visual clue as to a single orientation that will match the correct unlock position. In the case of a rectangle at least two orientations will match the footprint of an unlock position even though only one will be correct. In such an instance, it may require that one try each of multiple orientations or it may require that there be an additional visual clue as to the correct orientation. Often times, puzzle pieces when properly positioned form an image, which serves to provide a visual clue as to the proper position of each piece. Such an image could be used irrespective of whether the shape being used is a rectangle or a more traditional puzzle piece type shape. In any event by requiring a correct location as well as a correct orientation, the chances of an inadvertent unlocking of the device is diminished, while the ability of the user to discern the correct position of display element to unlock the device can still be readily determined and correspondingly performed through either a single gesture that affects both location and orientation, or multiple sequential gestures for matching the display element to its unlock position.

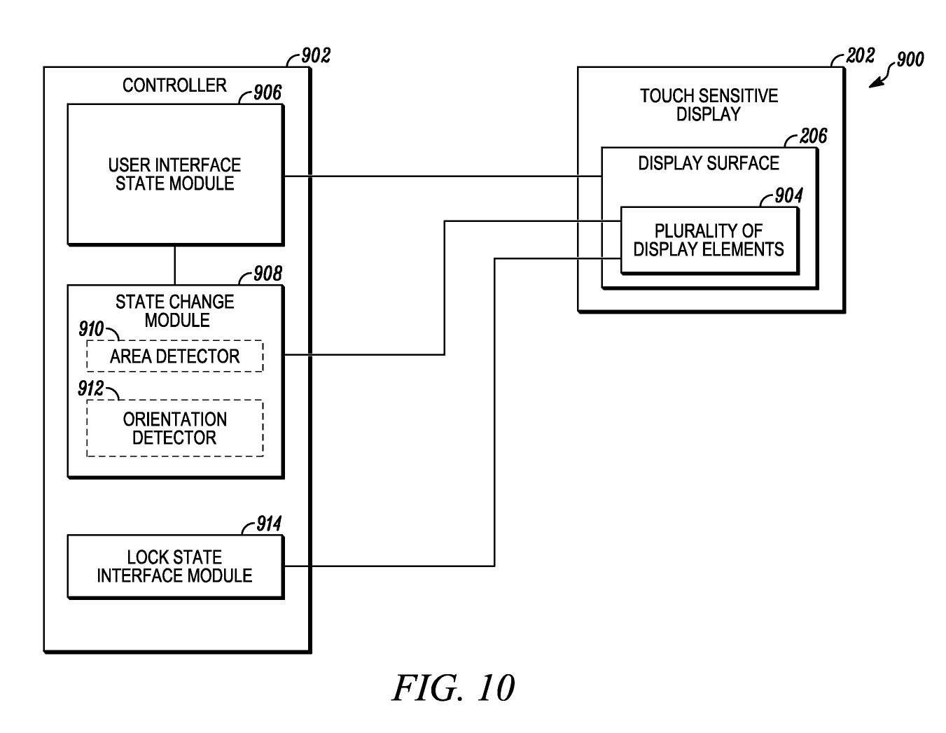

FIG. 10 illustrates a further block diagram 900 of a user interface incorporated as part of an electronic device. Similar to the block diagram 200 of a user interface illustrated in FIG. 3, the user interface illustrated in FIG. 10 includes a touch sensitive display 202 and a controller 904. The touch sensitive interface 202 includes a display surface 206, which includes a plurality of display elements 904 for presentation to the user via the display surface with which the user can interact. The display surface 206 of the touch sensitive display is similarly adapted for receiving a gesture or pattern of interaction from a user either directly, or indirectly via a pointing device. The detected gesture or pattern of interaction can then be interpreted in order to discern a desired action on the part of the user. In initially presenting a plurality of display elements in a locked state, some of the display elements may already be in their respective unlock position. However at least one of the display elements will be in a lock position.

The controller 902 manages the state of the user interface between a locked state and an unlocked state. In support of this function, the controller 902 includes a user interface state module 906, which is similar to the user interface state module 210 discussed above in connection with FIG. 3, and which selectively enables and disables at least a portion of the user interface, including the types of interactions to which the interface will respond. While in a locked state all or portions of the user interface can be disabled with the exception of detecting user interactions that are intended to transition the device back to an unlocked state. In disabling portions of the user interface, the portions that are disabled can correspond to one or more applications that are being executed by the device, as well as portions of the user interactive elements of the device including portions of the display sensitive surface intended to interact with one or more functions of the device.

The controller further similarly includes a state change module 908, which is adapted for switching the state of the user interface managed by the user interface state module 906, between a locked state and an unlocked state. The state change module switches the state of the user interface module from the locked state to the unlocked state when the state change module detects that each of the plurality of display elements are in their respective unlock position, which generally includes placement within a respective predetermined area. In some instances determining when the display elements are each in their respective areas of their unlock positions, can involve the state change module including an area detector 910 and/or an orientation detector 912.

The controller 204 further includes a lock state interface module 914 which manages the functioning of at least a portion of the device while the user interface is in a locked state. As part of that management, the lock state interface module 914 monitors interactions with the touch sensitive surface of the display, and detects interactions with elements being displayed during the locked state of the user interface state module 906. The lock state interface module 906 further manages the elements 904 being displayed including their subsequent selection and movement including those intentionally or unintentionally prompted by the user, while the device is in a locked state.

When in a locked state, the user interface presents to the user a plurality of display elements each having a current respective position. Some of which may correspond to a lock position, and some of which may correspond to an unlock position. The act of unlocking generally requires a selection of each of the display elements in a lock position, and a corresponding movement of that display element from a lock position to an unlock position. As noted above this can include placement within a particular area as well as can include a particular orientation.

The lock state interface module 914 in addition to managing the movement of display elements from their respective lock position to their respective unlock position, can manage the movement of a display element already in their unlock position to a position outside of their unlock position (or in other words to a lock position). While generally, a user interacting with the touch sensitive display in an effort to purposely unlock the device will only interact with the display elements that are not already in their unlock position, where the user interactions being detected by the device are unintentional, the unintentional interactions will generally not distinguish between display elements already in their unlock position and a display element in a lock position. When an unintended interaction moves a display element from an unlock position to a lock position, the device now has an additional element that needs to be transitioned back to its unlock position before the user interface of the device will transition to an unlocked state.

Generally, the default initial condition when the device is first put into a locked condition, will involve the placement of one or two display elements in a position other than their respective unlock position. That means that generally a majority of the plurality of display elements will already be in their respective unlock position. However, where a user is likely able to discern and focus on the movement of only the display elements that are not already in their unlock position, interactions that are not being purposely directed by the user tend to be blind and random, and therefore they are likely to select a display element already in an unlock position and move it out of its unlock position, because initially there are more display elements already in their unlock position. When this occurs, the device is moved further away from an unlocked condition, where not only do the display elements initially positioned in a lock position still need to be moved to their unlock position, but now at least one of the display elements that was initially in their unlock position needs to be moved back to its lock position, which in turn further decreases the chance of an inadvertent unlocking of the device.

If a user then subsequently attempts to unlock the device and the display elements have not been too scrambled through inadvertent interactions with the device, the user can move the few display elements not in their unlock position to their unlock position in order to unlock the device. However, if the display elements have been significantly scrambled through one or more inadvertent interactions, the user interface can include a reset gesture that can reset the display elements back to their initial conditions when the device was first locked with a majority of the display elements in their unlock position, and only one or a few display elements needing to be moved from a lock position to an unlock position. At least one example of a reset gesture can include touching corners (i.e. opposite corners) of the display surface at proximately the same time. Alternatively the corners of the display surface can be touched in a predetermined sequence for furnishing a reset gesture. A reset gesture can also involve another user interface element, such as a switch having a physically movable actuator.

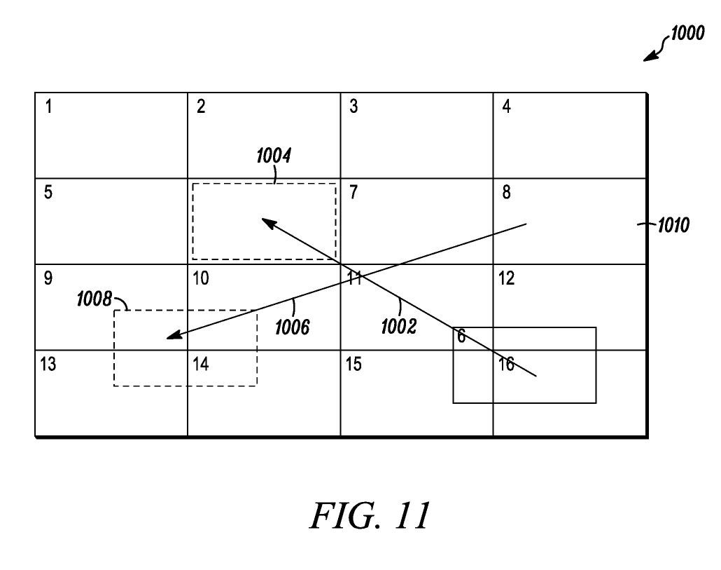

FIG. 11 illustrates a plan view 1000 of a plurality of display elements each having a respective unlock position highlighting the possibility of repositioning of corresponding display elements from a lock position to an unlock position, as well as the possibility of repositioning a corresponding display element from an unlock position to a lock position. In the illustrated embodiment, a majority of the display elements are shown in their respective unlocked position. In the illustrated embodiment, only display element 6 is not in its respective unlock position. More specifically, element 6 is overlaying portions of elements 11, 12, 15 and 16. In order for a user to unlock the device, the user would select element 6 and relocate it as part of a gesture 1002 that moves the display element to its respective unlock position 1004. The respective unlock position 1004 is highlighted as a box formed with dashed lines.

In selecting the display element 6, the interface may give preference to selecting a display element in a lock position over an element already in an unlock position. Correspondingly, where display element 6 overlaps portions of display elements 11, 12, 15 and 16, a selection in the overlap area will select display element 6. However if another location is selected with the exception of the unlock position of display element 6 where currently no display element resides, a display element already in an unlock position will be selected with the possibility that it will be moved out of its respective unlock position. For example, if display element 8 is selected it could be moved 1006 to a place 1008 other than its respective unlock position 1010. Generally, someone purposely trying to unlock the device will not move display elements already in their respective unlock position. However under the illustrated conditions, inadvertent interactions being generally blind are more likely to select and move a display element already in an unlock position, than it is to select and move a display element in a lock position to its unlock position. If that occurs, then it effectively becomes even less likely that further inadvertent interactions will unlock the display.

In at least some embodiments, the controller 204, illustrated in FIG. 3, and the controller 902, illustrated in FIG. 10, could be implemented in the form of a microprocessor, which is adapted to execute one or more sets of prestored instructions, which may be used to form at least part of one or more controller modules 210, 212 and/or 218, or 906, 908 and/or 914. The one or more sets of prestored instructions may be stored in a storage element, not shown, which may be integrated as part of the controller or may be coupled to the controller.

A storage element could include one or more forms of volatile and/or non-volatile memory, including conventional ROM, EPROM, RAM, or EEPROM. The storage element may still further incorporate one or more forms of auxiliary storage, which is either fixed or removable, such as a harddrive or a floppydrive. One skilled in the art will still further appreciate, that still other further forms of memory could be used without departing from the teachings of the present disclosure. In the same or other instances, the controller 204 or 906 may additionally or alternatively incorporate state machines and/or logic circuitry, which can be used to implement at least partially, some of modules and their corresponding functionality.

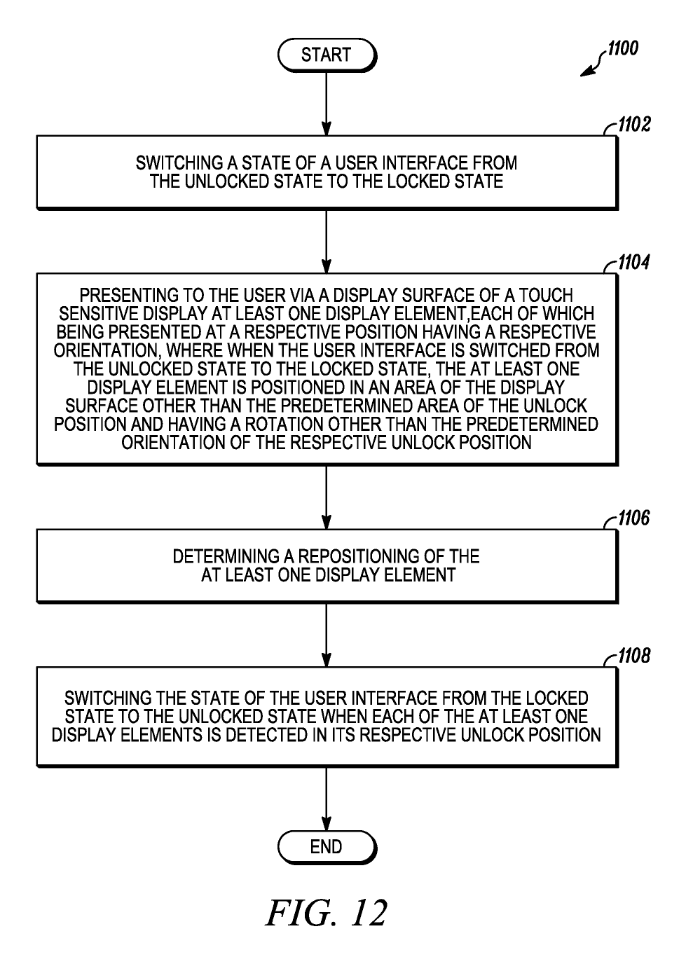

FIG. 12 illustrates a flow diagram of a method 1100 for managing a state of a user interface between a locked state and an unlocked state. The method includes, at 1102, switching a state of the user interface from the unlocked state to the locked state. At 1104, at least one display element is presented to the user via the touch sensitive display at a respective position having a respective orientation. When the state of the user interface is switched to a locked state, the at least one display element is positioned in an area other than the respective unlock position, and having a rotation other than a predetermined orientation of the respective unlock position. At 1106, a user interaction is then detected via the touch sensitive display, which includes a selection of a display element and a postselection gesture which affects the movement of the display element. At 1108, the state of the user interface is switched to an unlocked state when each of the display elements are detected in their respective unlock position.

As noted previously, when in a locked state, at least a portion of the types of interactions that are generally allowed by the user interface are restricted. This can include all general access to the device with the exception of the actions which are interpreted in association with any perceived attempted unlocking of the device, or it can include access to one or more features or functions including access to one or more applications operating on the device. Access to these portions of the user interface will generally be restricted until the user interface is placed in an unlocked state, through the user executing a set of one or more actions relative to the device which triggers an unlocking of the user interface. In this way, unintended interactions which can trigger unintended consequences can be reduced.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A user interface for an electronic device comprising:
a touch sensitive display having a display surface, the touch sensitive display being adapted for presenting to a user at a respective position having a respective orientation at least one display element along the display surface, and the touch sensitive display being further adapted for receiving from the user a user interaction with the touch sensitive display at a location along the display surface;
a controller including
a user interface state module having an unlocked state and a locked state adapted for selectively enabling and disabling at least a portion of the user interface, wherein the portion of the user interface responds to a predetermined type of user interaction when in the unlocked state and does not respond to the predetermined type of user interaction when in the locked state; and
a state change module adapted for switching the state of the user interface state module between the locked state and the unlocked state, the state change module switches the state of the user interface module from the locked state to the unlocked state when the state change module detects each of the at least one display element in a respective unlock position for the corresponding one of the at least one display element, the state change module including an area detector and an orientation detector, wherein the respective unlock position for the corresponding one of the at least one display element includes a placement within a respective predetermined area and a rotational direction in a respective predetermined orientation, and wherein when the state change module switches the state of the user interface state module to a locked state, the state change module is adapted to respectively reposition at least one display element to a respective lock position including an area of the display surface other than within the respective predetermined area of the respective unlock position and to an orientation other than the respective predetermined orientation of the respective unlock position.

2. A user interface for an electronic device in accordance with claim 1, wherein the controller further includes a lock state interface module, said lock state interface module being adapted to detect a received user interaction including the selection by the user of one of the at least one display element, and being further adapted to detect a further received user interaction including a postselection gesture, which moves the display element from a preselection position to a postgesture position having at least one of a placement within a new area and a new orientation.

3. A user interface for an electronic device in accordance with claim 2, wherein the at least one of placement within a new area and a new orientation by the post selection gesture includes movement of the selected one of the at least one display element from the respective lock position to the respective unlock position, and movement of the selected one of the at least one display element from the respective unlock position to the respective lock position.

4. A user interface for an electronic device in accordance with claim 2, wherein the postselection gesture includes a path which is traced proximate the display surface of the touch sensitive display by the user using a pointer having a position that moves along the path, and wherein if a current position of the pointer along the traced path coincides with an avoid area, the display element is returned to the preselection position of the display element.

5. A user interface for an electronic device in accordance with claim 2, wherein the postselection gesture includes a path which is traced proximate the display surface of the touch sensitive display by the user using a pointer having a position that moves along the path, and wherein the new orientation associated with the postgesture position of the selected one of the at least one display element is arranged such that a line extending between the center of the selected one of the at least one display element and a point of selection of the selected one of the at least one display element is parallel to the direction of the path at the end of the postselection gesture.

6. A user interface for an electronic device in accordance with claim 2, wherein the postselection gesture includes a multi-touch gesture including two points of interaction each tracing a respective path relative to the display surface of touch sensitive display, where the direction and the amount of rotation of the selected display element in establishing the new orientation of the postgesture position of the selected display element is a function of the movement along the respective path of each of the two points of interaction.

7. A user interface for an electronic device in accordance with claim 6, wherein one of the two points of interaction is a pivot point for the selected display element for use in establishing the direction and the amount of rotation.

8. A user interface for an electronic device in accordance with claim 6, wherein a pivot point about which the selected display element rotates is defined as the center of two points of interaction for use in establishing the direction and the amount of rotation.

9. A user interface for an electronic device in accordance with claim 1, wherein each of the at least one display element is a puzzle piece.

10. A user interface for an electronic device in accordance with claim 9, wherein the display element has a shape which is asymmetric.

11. A user interface for an electronic device in accordance with claim 9, wherein the display element has an image, which matches a portion of a larger image associated with the respective unlock area associated with the display element.

12. A user interface for an electronic device in accordance with claim 1, wherein the at least the portion of the user interface, which does not respond to the predetermined type of user interaction, when in the locked state includes user interface elements in addition to user interface elements associated with the touch sensitive display.

13. A user interface for an electronic device comprising:
a touch sensitive display having a display surface, the touch sensitive display being adapted for presenting to a user at a respective position a plurality of display elements along the display surface, and the touch sensitive display being further adapted for receiving from the user a user interaction with the touch sensitive display at a location along the display surface;
a controller including
a user interface state module having an unlocked state and a locked state adapted for selectively enabling and disabling at least a portion of the user interface, wherein the portion of the user interface responds to a predetermined type of user interaction when in the unlocked state and does not respond to the predetermined type of user interaction when in the locked state;
a state change module adapted for switching the state of the user interface state module between the locked state and the unlocked state, the state change module switches the state of the user interface module from the locked state to the unlocked state when the state change module detects each of the plurality of display elements in respective unlock positions for each of the corresponding display elements, the state change module including a position detector wherein the respective unlock position for a corresponding one of the plurality of display elements includes placement within a respective predetermined position, and wherein when the state change module switches the state of the user interface state module to a locked state, the state change module is adapted to respectively reposition at least one of the plurality of display elements to a position of the display surface other than within the respective unlock position; and
a lock state interface module, said lock state interface module being adapted to detect a received user interaction including the selection by the user of one of the plurality of display elements, and being further adapted to detect a further received user interaction including a postselection gesture, which moves the selected one of the plurality of display elements from a preselection position to a postgesture position having a placement within a new position, wherein in addition to being adapted to move the selected one of the plurality of display elements from the respective lock position to the respective unlock position, the lock state interface module is adapted to move the selected one of the plurality of display elements from the respective unlock position to the respective lock position.

14. A user interface for an electronic device in accordance with claim 13, wherein when the state change module switches the state of the user interface state module to a locked state, the state change module is adapted to initially establish a position of each of a majority of the plurality of display elements within the respective predetermined unlock position.

15. A user interface for an electronic device in accordance with claim 13, wherein when the state change module switches the state of the user interface state module to a locked state, the state change module is adapted to initially establish a position of all but one of the plurality of display elements within the respective predetermined unlock position.

16. A user interface for an electronic device in accordance with claim 13, wherein the respective unlock position for a corresponding one of the plurality of display elements includes having a placement within a respective predetermined area and having a respective predetermined orientation.

17. A method for managing a state of a user interface between a locked state and an unlocked state, the method comprising:
switching a state of the user interface from the unlocked state to the locked state;
presenting to the user via a display surface of a touch sensitive display at least one display element, each of the at least one display element being presented at a respective position having a respective orientation, wherein when the state of the user interface is switched from the unlocked state to the locked state, the at least one display element is positioned in an area of the display surface other than a predetermined area of a respective unlock position and having a rotation other than a predetermined orientation of the respective unlock position;
detecting a repositioning of the at least one display element;
switching the state of the user interface from the locked state to the unlocked state, when each of the at least one display element is detected in the respective unlock position of the corresponding at least one display element.

18. A method for managing a state of a user interface in accordance with claim 17, wherein detecting a repositioning of the at least one display element includes detecting via the touch sensitive display a user interaction proximate the display surface comprises a selection by the user of one of the at least one display element and a postselection gesture, which directs the movement of the display element from a preselection position to a postgesture position having at least one of a placement in a new area and a new orientation.

19. A method for managing a state of a user interface in accordance with claim 18, where in addition to moving the selected at least one display element from a position other than the respective unlock position to the respective unlock position, the movement of the display element from the preselection position to the postgesture position can move the selected at least one display element from the respective unlock position to the position other than the respective unlock position.

20. A method for managing a state of a user interface in accordance with claim 18, wherein the postselection gesture includes following a path which is traced proximate the display surface of the touch sensitive display by the user using a pointer having a position that moves along the path, and wherein if a current position of the pointer along the traced path coincides with an avoid area, the display element is returned to the preselection position of the display element.
